(19) United States
(12) Patent Application Publication
(10) Pub. No.: US 2007/0218193 A1
(43) Pub. Date: Sep. 20, 2007

(54) Method of manufacturing interconnect substrate

(75) Inventors: Satoshi Kimura, Fujimi (JP); Hidemichi Furihata, Chino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/716,719

(22) Filed: Mar. 9, 2007

(30) Foreign Application Priority Data
Mar. 10, 2006 (JP) 2006-065987

(51) Int. Cl. B05D 5/12; B28B 19/00

(52) U.S. Cl. 427/99.5; 427/99.1

(57) ABSTRACT

A method of manufacturing an interconnect substrate by electroless plating which causes a metal to be deposited without using a plating resist, the method including: (a) immersing a substrate in a catalyst solution including palladium, hydrogen peroxide, and hydrochloric acid to form a catalyst layer on the substrate; and (b) depositing a metal on the catalyst layer by immersing the substrate in an electroless plating solution to form a metal layer.

Japanese Patent Application No. 2006-65987, filed on Mar. 10, 2006, is hereby incorporated by reference in its entirety.

### BACKGROUND OF THE INVENTION

The present invention relates to a method of manufacturing an interconnect substrate.

Along with a recent increase in speed and density of electronic instruments, an additive method has attracted attention as a method of manufacturing an interconnect substrate. As the additive method, a method has been known which includes patterning a photoresist provided on a substrate to form a plating resist and plating openings in the plating resist to deposit a metal layer. JP-A-10-140364 discloses an electroless plating solution for plating using a plating resist.

According to this method, since a step of removing a plating resist is required, the number of manufacturing steps is increased. To deal with this problem, a method of depositing a metal layer without using a plating resist has attracted attention.

When depositing a metal layer by electroless plating, a substrate is generally immersed in an electroless plating solution. Metal colloid particles contained in the electroless plating solution are deposited on the substrate to form metal particles, and the metal particles aggregate to form a metal layer. Accordingly, the minimum unit of the metal layer is determined by the particle diameter of the metal particle formed of the metal colloid particle. Therefore, in order to accurately form high-density interconnects when using the method of depositing a metal layer without using a plating resist, it is important to adjust the particle diameter of the metal colloid particles contained in the electroless plating solution to a value suitable for the interconnect width.

### SUMMARY

According to a first aspect of the invention, there is provided a method of manufacturing an interconnect substrate by electroless plating which causes a metal to be deposited without using a plating resist, the method comprising:
(a) immersing a substrate in a catalyst solution including palladium, hydrogen peroxide, and hydrochloric acid to form a catalyst layer on the substrate; and
(b) depositing a metal on the catalyst layer by immersing the substrate in an electroless plating solution to form a metal layer.

According to a second aspect of the invention, there is provided a method of manufacturing an interconnect substrate by electroless plating which causes a metal to be deposited without using a plating resist, the method comprising:
(a) immersing a substrate in a catalyst solution to form a catalyst layer on the substrate; and
(b) depositing a metal on the catalyst layer by immersing the substrate in an electroless plating solution having a pH adjusted to 4.1 to 4.4 to form a metal layer.

According to a third aspect of the invention, there is provided a catalyst solution for electroless plating comprising:
a mixed aqueous solution including palladium, hydrogen peroxide, and hydrochloric acid.

### BRIEF DESCRIPTION OF THE SEVERAL VIEWS OF THE DRAWING

FIG. 1 is a diagram showing a method of manufacturing an interconnect substrate according to one embodiment of the invention.

FIG. 2 is a diagram showing a method of manufacturing an interconnect substrate according to one embodiment of the invention.

FIG. 3 is a diagram showing a method of manufacturing an interconnect substrate according to one embodiment of the invention.

FIG. 4 is a diagram showing a method of manufacturing an interconnect substrate according to one embodiment of the invention.

FIG. 5 is a diagram showing a method of manufacturing an interconnect substrate according to one embodiment of the invention.

FIG. 6 is a diagram showing a method of manufacturing an interconnect substrate according to one embodiment of the invention.

FIG. 7 is a diagram showing a method of manufacturing an interconnect substrate according to one embodiment of the invention.

FIG. 8 is a diagram showing a method of manufacturing an interconnect substrate according to one embodiment of the invention.

FIG. 9 shows an example of an electronic device to which an interconnect substrate according to one embodiment of the invention is applied.

### DETAILED DESCRIPTION OF THE EMBODIMENT

The invention may provide a method of manufacturing an interconnect substrate capable of accurately forming high-density interconnects without using a plating resist.

According to one embodiment of the invention, there is provided a method of manufacturing an interconnect substrate by electroless plating which causes a metal to be deposited without using a plating resist, the method comprising:
(a) immersing a substrate in a catalyst solution including palladium, hydrogen peroxide, and hydrochloric acid to form a catalyst layer on the substrate; and
(b) depositing a metal on the catalyst layer by immersing the substrate in an electroless plating solution to form a metal layer.

In this method of manufacturing an interconnect substrate, the catalyst solution may have a pH adjusted to 4.0 to 6.9.

In this method of manufacturing an interconnect substrate, the catalyst solution may have a pH adjusted to 4.0 to 5.0.

In this method of manufacturing an interconnect substrate, the electroless plating solution may have a pH adjusted to 4.1 to 4.4.

In this method of manufacturing an interconnect substrate, the electroless plating solution may include nickel.

According to one embodiment of the invention, there is provided a method of manufacturing an interconnect substrate by electroless plating which causes a metal to be deposited without using a plating resist, the method comprising:
(a) immersing a substrate in a catalyst solution to form a catalyst layer on the substrate; and
(b) depositing a metal on the catalyst layer by immersing the substrate in an electroless plating solution having a pH adjusted to 4.1 to 4.4 to form a metal layer.

In this method of manufacturing an interconnect substrate, the electroless plating solution may include nickel.

The above-described methods of manufacturing an interconnect substrate may further comprise:
forming a resist layer on the substrate in a region other than a region of a desired interconnect pattern before the step (a);
forming a surfactant layer including a surfactant on the substrate before the step (a); and
removing the resist layer to remove the surfactant layer and the catalyst layer in the region other than the region of the desired interconnect pattern after the step (a).

According to one embodiment of the invention, there is provided a catalyst solution for electroless plating comprising:
a mixed aqueous solution including palladium, hydrogen peroxide, and hydrochloric acid.

Some embodiments of the invention will be described below with reference to the drawings.

### 1. METHOD OF MANUFACTURING INTERCONNECT SUBSTRATE

FIGS. 1 to 8 are diagrams showing a method of manufacturing an interconnect substrate 100 (see FIG. 8) according to one embodiment of the invention. In this embodiment, the interconnect substrate is manufactured by applying electroless plating.

(1) A substrate 10 is provided. The substrate 10 may be an insulating substrate, as shown in FIG. 1. The substrate 10 may be an organic substrate (e.g. plastic material or resin substrate) or an inorganic substrate (e.g. quartz glass, silicon wafer, or oxide layer). As examples of the plastic material, polyimide, polyethylene terephthalate, polycarbonate, polyphenylene sulfide, and the like can be given. The substrate 10 may be a light-transmitting substrate (e.g. transparent substrate). The substrate 10 includes a single-layer substrate and a multilayer substrate in which at least one insulating layer is formed on a base substrate. In this embodiment, a metal layer is formed on the substrate 10.

A resist layer 22 is formed. The resist layer 22 may be formed as shown in FIG. 1 by applying a resist (not shown) to the top surface of the substrate 10 and patterning the resist using a lithographic method. The resist layer 22 is formed in a region other than the region of a desired interconnect pattern.

(2) The substrate 10 is washed. The substrate 10 may be dry-washed or wet-washed. It is preferable to dry-wash the substrate 10. The resist layer 22 can be prevented from being damaged (e.g. separated) by dry-washing the substrate 10.

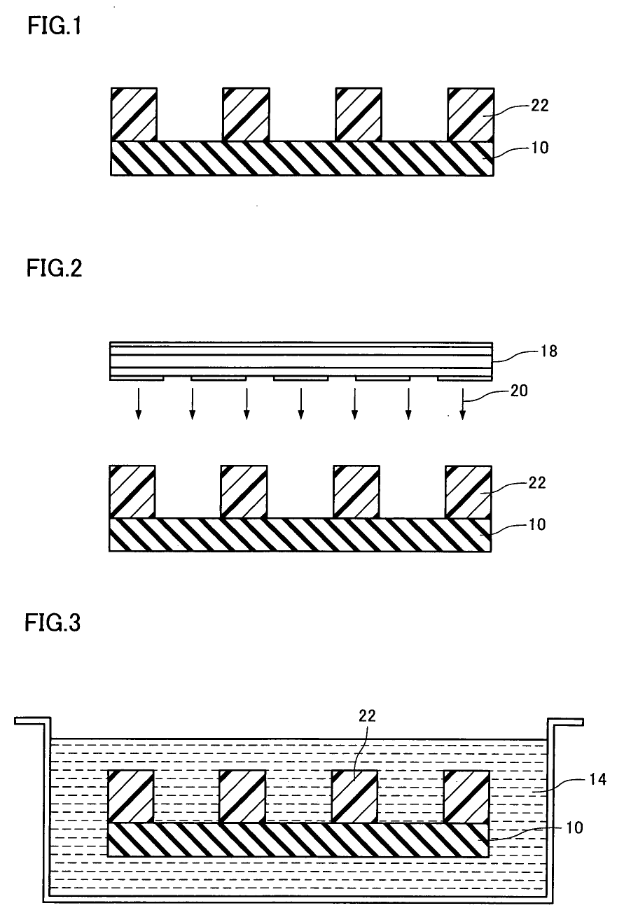

As shown in FIG. 2, the substrate 10 may be dry-washed by applying vacuum ultraviolet radiation for 30 to 900 seconds in a nitrogen atmosphere using a vacuum ultraviolet lamp. Soil such as oils adhering to the surface of the substrate 10 can be removed by washing the substrate 10. Moreover, the water-repellent surfaces of the substrate 10 and the resist layer 22 can be made hydrophilic. When the surface potential in liquid of the substrate 10 is negative, a surface at a uniform negative potential can be formed by washing the substrate 10.

The substrate 10 may be wet-washed by immersing the substrate 10 in ozone water (ozone concentration: 10 to 20 ppm) at room temperature for about 5 to 30 minutes, for example. The substrate 10 may be dry-washed by applying vacuum ultraviolet radiation for 30 to 900 seconds in a nitrogen atmosphere using a vacuum ultraviolet lamp (wavelength: 172 nm, output: 10 mW, sample-to-sample distance: 1 mm).

(3) As shown in FIG. 3, the substrate 10 is immersed in a surfactant solution 14. The surfactant contained in the surfactant solution 14 may be a cationic surfactant or an anionic surfactant. When the surface potential in liquid of the substrate 10 is negative, it is preferable to use the cationic surfactant. This is because the cationic surfactant is easily adsorbed on the substrate 10 in comparison with other surfactants. When the surface potential in liquid of the substrate 10 is positive, it is preferable to use the anionic surfactant as the surfactant contained in the surfactant solution 14.

As the cationic surfactant, a water-soluble surfactant containing an aminosilane component, an alkylammonium surfactant (e.g. cetyltrimethylammonium chloride, cetyltrimethylammonium bromide, or cetyldimethylammonium bromide), or the like may be used. As the anionic surfactant, a polyoxyethylene alkyl ether sulfate (sodium dodecyl sulfate, lithium dodecyl sulfate, or N-lauroylsarcosine) or the like may be used. The immersion time may be about 1 to 10 minutes, for example.

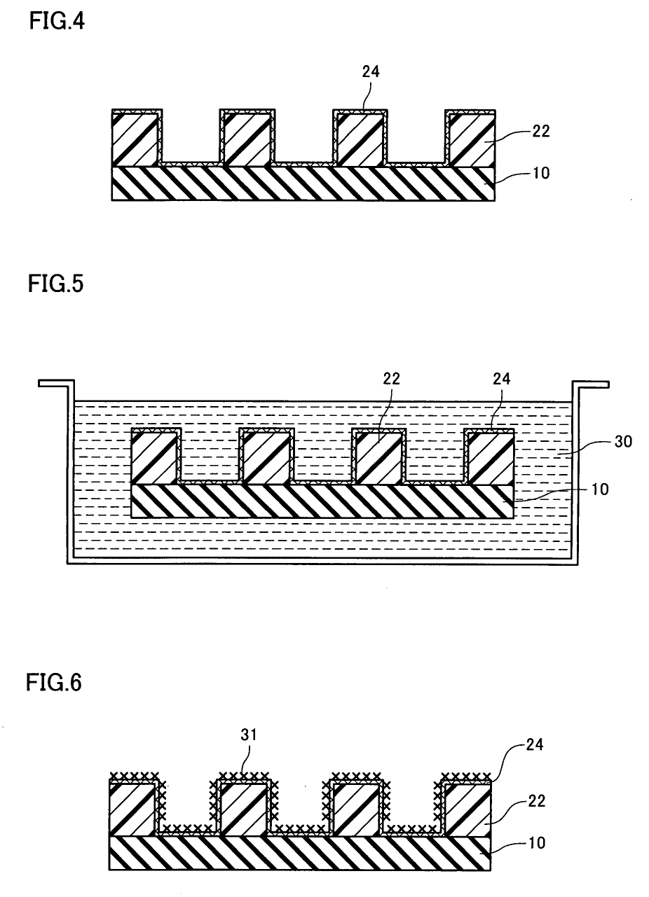

The substrate 10 is removed from the surfactant solution and washed with ultrapure water. After air-drying the substrate 10 at room temperature or removing waterdrops by spraying compressed air, the substrate 10 is dried in an oven at 90 to 120° C. for about 10 minutes to 1 hour. A surfactant layer 24 (see FIG. 4) can be formed on the substrate 10 by the above steps. When using the cationic surfactant as the surfactant, the surface potential in liquid of the substrate 10 is shifted to the positive potential side in comparison with the surface potential before adsorption.

(4) As shown in FIG. 5, the substrate 10 is immersed in a catalyst solution 30. The catalyst solution 30 includes a catalyst component which functions as a catalyst for electroless plating. For example, palladium may be used as the catalyst component.

The catalyst solution 30 may be prepared as follows, for example.

(4a) Palladium pellets with a purity of 99.99% are dissolved in a mixed solution of hydrochloric acid, hydrogen peroxide solution, and water to prepare a palladium chloride solution with a palladium concentration of 0.1 to 0.5 g/l. The mixed solution of hydrochloric acid, hydrogen peroxide solution, and water is preferably prepared by adding 50 to 200 ml of 35% hydrochloric acid and 50 to 200 ml of a 30% hydrogen peroxide solution to 600 ml of water.

(4b) The palladium concentration of the palladium chloride solution is adjusted to 0.01 to 0.05 g/l by diluting the palladium chloride solution with water and a hydrogen peroxide solution. As the mixing ratio of water and a hydrogen peroxide solution, it is preferable to mix 250 ml of water and 5 to 30 ml of a 30% hydrogen peroxide solution.

(4c) The pH of the palladium chloride solution is adjusted to 4.0 to 6.9, and preferably 4.0 to 5.0 using a sodium hydroxide aqueous solution or the like. A catalyst solution suitable for forming the catalyst layer can be prepared by adjusting the pH of the palladium chloride solution in this manner.

It suffices that the final catalyst solution 30 have the above-mentioned pH. The order of addition of each solution is not particularly limited. For example, the hydrogen peroxide solution may be added after adjusting the pH using the sodium hydroxide aqueous solution.

The substrate 10 may be washed with water after immersing the substrate 10 in the catalyst solution 30. The substrate 10 may be washed with pure water. A catalyst residue can be prevented from being mixed into an electroless plating solution described later by washing the substrate 10 with water.

A catalyst layer 31 is formed by the above steps. As shown in FIG. 6, the catalyst layer 31 is formed on the top surface of the surfactant layer 24 formed on the substrate 10 and the resist layer 22.

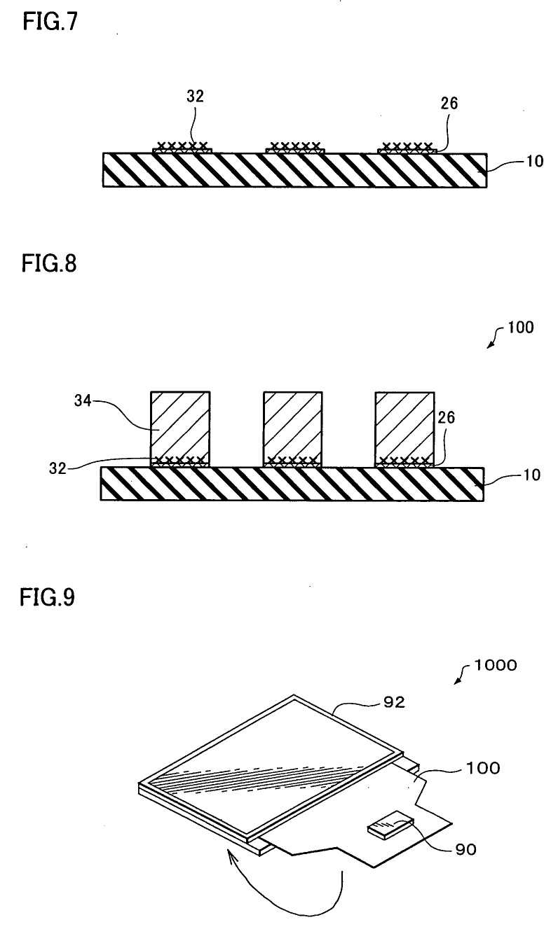

As shown in FIG. 7, the resist layer 22 is removed to form the surfactant layer 26 and the catalyst layer 32 having a desired interconnect pattern. The resist layer 22 may be removed using acetone or the like. The surfactant layer 24 and the catalyst layer 31 formed on the resist layer 22 are also removed together with the resist layer 22.

(5) A metal layer 34 is deposited on the catalyst layer 32. In more detail, the metal layer 34 may be deposited on the catalyst layer 32 by immersing the substrate 10 in an electroless plating solution (see FIG. 8).

The electroless plating solution is classified as an electroless plating solution used in an acidic region or an electroless plating solution used in an alkaline region. In this embodiment, an electroless plating solution used in an acidic region is applied. When depositing a nickel layer as the metal layer 34, the electroless plating solution includes nickel, a reducing agent, a complexing agent, and the like. Specifically, an electroless plating solution may be used which mainly includes nickel sulfate hexahydrate or nickel chloride hexahydrate and includes sodium hypophosphite as the reducing agent. In this embodiment, the pH of the electroless plating solution is adjusted to 4.1 to 4.4. The pH of a commercially-available electroless plating solution is usually about 4.5 to 5.0. The pH of the electroless plating solution may be adjusted by adding a strong acid reagent such as sulfuric acid or hydrochloric acid to the electroless plating solution. The pH of the electroless plating solution may also be adjusted by changing the amount of reducing agent added and the like.

For example, a nickel layer with a thickness of 20 to 100 nm may be formed by immersing the substrate 10 in an electroless plating solution (temperature: 70 to 80° C.) containing nickel sulfate hexahydrate for about 10 seconds to 10 minutes. The material for the metal layer 34 is not particularly limited insofar as the material undergoes plating reaction in the presence of a catalyst. The metal layer 34 may also be formed of platinum (Pt), gold (Au), or the like. The metal layer 34 can be thus formed on the top surface of the catalyst layer 32 on the substrate 10.

The interconnect substrate 100 can be formed by the above steps. In the method of manufacturing the interconnect substrate 100 according to this embodiment, the catalyst layer is formed using the catalyst solution prepared by using palladium, hydrogen peroxide, and hydrochloric acid. This catalyst solution includes only palladium, hydrogen, oxygen, sodium, and chlorine as the components, and does not include a surfactant, a complexing agent, and the like. Therefore, a molecule with a large molecular weight, a bulky functional group, or the like does not enter the space between palladium atoms forming the palladium colloid particles in the catalyst solution, whereby the size of the palladium colloid particles can be reduced. Therefore, a catalyst layer with a minute pattern can be accurately formed by using such a catalyst solution, whereby high-density interconnects can be accurately formed.

In this embodiment, the pH of the electroless plating solution is adjusted to 4.1 to 4.4. Specifically, the pH of the electroless plating solution is changed so that the metals in the electroless plating solution are ionized. The size of the metal colloid particles in the electroless plating solution can be reduced by ionizing the metals. Therefore, a metal layer with a minute pattern can be accurately formed by using such an electroless plating solution.

### 2. ELECTRONIC DEVICE

FIG. 9 shows an example of an electronic device to which an interconnect substrate manufactured by the method of manufacturing an interconnect substrate according to one embodiment of the invention is applied. An electronic device 1000 includes the interconnect substrate 100, an integrated circuit chip 90, and another substrate 92.

The interconnect pattern formed on the interconnect substrate 100 may be used to electrically connect electronic parts. The interconnect substrate 100 is manufactured by the above-described manufacturing method. In the example shown in FIG. 9, the integrated circuit chip 90 is electrically connected with the interconnect substrate 100, and one end of the interconnect substrate 100 is electrically connected with the other substrate 92 (e.g. display panel). The electronic device 1000 may be a display device such as a liquid crystal display device, a plasma display device, or an electroluminescent (EL) display device.

### 3. EXPERIMENTAL EXAMPLES

### 3.1. First Experimental Example

An interconnect substrate was formed by using the method of manufacturing an interconnect substrate according to this embodiment.

(1) A photoresist film was formed on a glass substrate. The photoresist film was exposed and developed by using a direct writing method in the shape of straight lines with a width of about 800 nm at a pitch of about 1 micrometer to form a photoresist having straight lines with a width of about 200 nm and stripe-shaped openings with a width of about 800 nm.

(2) The glass substrate was cut in the shape of a 1×1 cm square. The glass substrate was then immersed in a cationic surfactant solution (FPD conditioner manufactured by Technic Japan Incorporated), and sufficiently washed with water.

(3) A catalyst solution was prepared as follows. 100 ml of 35% hydrochloric acid (guaranteed reagent) and 100 ml of a 30% hydrogen peroxide solution (guaranteed reagent) were added to 600 ml of water to prepare a mixed solution of hydrochloric acid, a hydrogen peroxide solution, and water. 0.2 g of palladium pellets with a purity of 99.99% were placed in the above mixed solution and held for about 48 hours to dissolve to prepare a palladium chloride solution with a palladium concentration of about 0.25 g/l.

250 ml of water was added to 50 ml of the palladium chloride solution, and 20 ml of a hydrogen peroxide solution was added to the mixture. The pH of the palladium chloride solution was adjusted to about 6.0 using a sodium hydroxide aqueous solution or the like.

(4) The glass substrate was immersed in the above catalyst solution. The photoresist on the glass substrate was removed using an organic solvent such as acetone. The glass substrate was then sufficiently washed with water. A stripe-shaped catalyst layer having straight lines with a width of about 800 nm at intervals of about 200 nm was formed in this manner.

(5) The glass substrate on which the catalyst layer was formed was immersed in a nickel electroless plating solution (FPD nickel manufactured by Technic Japan Incorporated) (80° C.) of which the pH was adjusted to about 4.1 to 4.4. Metal layers with a thickness of about 30 to 50 nm and a width of about 850 nm were formed on the glass substrate at intervals of 150 nm.

### 3.2. Second Experimental Example (Comparative Example)

An interconnect substrate was formed by using the method of manufacturing an interconnect substrate according to this embodiment.

(1) A photoresist film was formed on a glass substrate. The photoresist film was exposed and developed by using a direct writing method in the shape of straight lines with a width of about 800 nm at a pitch of about 1 micrometer to form a photoresist having straight lines with a width of about 200 nm and stripe-shaped openings with a width of about 800 nm.

(2) The glass substrate was cut in the shape of a 1×1 cm square. The glass substrate was then immersed in a cationic surfactant solution (FPD conditioner manufactured by Technic Japan Incorporated), and sufficiently washed with water.

(3) The glass substrate was immersed in a commercially-available catalyst solution containing palladium. The catalyst solution contained palladium, a surfactant, and the like, and had a pH of 6.0. The photoresist on the glass substrate was removed using an organic solvent such as acetone. The glass substrate was then sufficiently washed with water. A stripe-shaped catalyst layer having straight lines with a width of about 800 nm at intervals of about 200 nm was formed in this manner.

(4) The glass substrate on which the catalyst layer was formed was immersed in a nickel electroless plating solution (FPD nickel manufactured by Technic Japan Incorporated) (80° C.) of which the pH was not adjusted. The pH of the nickel electroless plating solution was about 4.6.

Metal layers with a thickness of about 30 to 50 nm and a width of about 950 nm were thus formed on the glass substrate. The edge of the metal layer was curved and partially in contact with the adjacent portion.

### 4. EXPERIMENTAL RESULTS

In the first experimental example, the catalyst layer was formed using the catalyst solution containing palladium, hydrogen peroxide, and hydrochloric acid, and the nickel layer was formed using the electroless plating solution of which the pH was adjusted to 4.1 to 4.4. In the second experimental example, the catalyst layer was formed using the commercially-available catalyst solution, and the nickel layer was formed using the nickel electroless plating solution at a normal pH. Since the width of the nickel layer formed in the second experimental example was about 950 nm, the edge of the line was irregular and curved. A portion was observed which was in contact with the adjacent portion.

The nickel layer formed in the first experimental example had a width of about 850 nm. It was confirmed that the nickel layer was formed in the first experimental example to a width smaller than that of the nickel layer formed in the second experimental example using the commercially-available catalyst solution. According to the first experimental example and the second experimental example, it was found that high-density interconnects can be accurately formed by using the catalyst solution containing palladium, hydrogen peroxide, and hydrochloric acid, whereby the reliability of the interconnect substrate can be improved.

The invention is not limited to the above-described embodiments. Various modifications and variations may be made. In the above-described embodiment, the resist layer is provided in advance on the substrate in the region other than the desired pattern region, the surfactant layer and the catalyst layer are formed on the entire surface, and the catalyst layer is formed in a specific region by removing the resist layer. Note that the catalyst layer may be formed without using the resist layer. Specifically, the surfactant layer is formed on the entire surface of the substrate, and the surfactant layer is partially optically decomposed to allow the surfactant layer to remain only in the desired pattern region. This allows the catalyst layer to be formed only in the desired pattern region. The surfactant layer may be optically decomposed using vacuum ultraviolet (VUV) radiation. An interatomic bond (e.g. C—C, C═C, C—H, C—F, C—Cl, C—O, C—N, C═O, O═O, O—H, H—F, H—Cl, and N—H) can be cut by setting the wavelength of light at 170 to 260 nm, for example. It becomes unnecessary to provide a yellow room or the like by using the above wavelength band, whereby a series of steps according to this embodiment can be performed under white light, for example.

The invention includes various other configurations substantially the same as the configurations described in the embodiments (in function, method and result, or in objective and result, for example). The invention also includes a configuration in which an unsubstantial portion in the described embodiments is replaced. The invention also includes a configuration having the same effects as the configurations described in the embodiments, or a configuration able to achieve the same objective. Further, the invention includes a configuration in which a publicly known technique is added to the configurations in the embodiments.

Although only some embodiments of the invention have been described in detail above, those skilled in the art will readily appreciate that many modifications are possible in the embodiments without materially departing from the novel teachings and advantages of this invention. Accordingly, all such modifications are intended to be included within the scope of the invention.

What is claimed is:

1. A method of manufacturing an interconnect substrate by electroless plating which causes a metal to be deposited without using a plating resist, the method comprising:
(a) immersing a substrate in a catalyst solution including palladium, hydrogen peroxide, and hydrochloric acid to form a catalyst layer on the substrate; and
(b) depositing a metal on the catalyst layer by immersing the substrate in an electroless plating solution to form a metal layer.

2. The method of manufacturing an interconnect substrate as defined in claim 1, wherein the catalyst solution has a pH adjusted to 4.0 to 6.9.

3. The method of manufacturing an interconnect substrate as defined in claim 1, wherein the catalyst solution has a pH adjusted to 4.0 to 5.0.

4. The method of manufacturing an interconnect substrate as defined in claim 1, wherein the electroless plating solution has a pH adjusted to 4.1 to 4.4.

5. The method of manufacturing an interconnect substrate as defined in claim 4, wherein the electroless plating solution includes nickel.

6. A method of manufacturing an interconnect substrate by electroless plating which causes a metal to be deposited without using a plating resist, the method comprising:
(a) immersing a substrate in a catalyst solution to form a catalyst layer on the substrate; and
(b) depositing a metal on the catalyst layer by immersing the substrate in an electroless plating solution having a pH adjusted to 4.1 to 4.4 to form a metal layer.

7. The method of manufacturing an interconnect substrate as defined in claim 6, wherein the electroless plating solution includes nickel.

8. The method of manufacturing an interconnect substrate as defined in claim 1, further comprising:
forming a resist layer on the substrate in a region other than a region of a desired interconnect pattern before the step (a);
forming a surfactant layer including a surfactant on the substrate before the step (a); and
removing the resist layer to remove the surfactant layer and the catalyst layer in the region other than the region of the desired interconnect pattern after the step (a).

9. A catalyst solution for electroless plating comprising:
a mixed aqueous solution including palladium, hydrogen peroxide, and hydrochloric acid.
